(19) United States
(12) Patent Application Publication
(10) Pub. No.: US 2004/0154203 A1
(43) Pub. Date: Aug. 12, 2004

(54) Luminescent means for control areas

(75) Inventors: Wolfgang Bredow, Niefern-Oschelbronn (DE); Thomas Burchard, Pforzheim (DE); Thomas Haug, Olbronn (DE)

Correspondence Address: BROWDY AND NEIMARK, P.L.L.C., 624 NINTH STREET, NW, SUITE 300, WASHINGTON, DC, 20001-5303, US

(73) Assignee: Integrated Electronic Systems !SYS Consulting GmbH, Olbronn-Durm (DE)

(21) Appl. No.: 10/771,296

(22) Filed: Feb. 5, 2004

(30) Foreign Application Priority Data
Feb. 6, 2003 (DE) DE 103 04 691.7

(51) Int. Cl. G09F 3/10

(52) U.S. Cl. 40/638

(57) ABSTRACT

A marking element for marking the function of a control element of an electric or electronic device with numbers or pictorial symbols. The marking element is composed of a first section composed of a first film having a luminescent layer to be applied to a control area of the control element, and a number or pictorial symbol is provided on the first section.

### BACKGROUND OF THE INVENTION

The present invention relates to a marking element, especially for control areas of electric/electronic devices, for marking the function of control elements by means of numbers and/or pictorial symbols.

Devices of many different types, especially electric or electronic devices, require the manual operation of control elements in order to function as intended, i.e., one or more control elements must be moved into a specific position to produce a defined function of the device. Such function may include, for example, rotation through a certain angle, or through operation by pressure.

To provide an identification of the function of such control elements and their possible positions, numbers or pictorial symbols are usually arranged in the immediate vicinity of one or more of these control elements, at locations that correspond to the operating positions to be taken by the control elements, or provide at least an indication of them. The proper functioning of the device thus depends on the recognizability or visibility of these numbers or pictorial symbols that are associated with the various control elements. This is of additional importance if the device to be operated is a device with which safety-relevant processes are controlled, such as, e.g., a remote control device in industrial remote control systems, where erroneous operation could possibly cause substantial damage. This case may arise, for example, if a sudden power outage causes an illuminated room to suddenly plunge into darkness; safe operation of the electronic device must remain ensured even in such a case.

It is known in various fields to use flat component parts, for example in the form of films, to achieve the stated purpose. German patent document DE 44 21 942 C2, for example, shows a panel that can be illuminated and to which, in the interior of an automobile, a luminescent film is attached. German patent document DE 202 01 224 U1 shows a sign wherein, for purposes of the recognizability of symbols, an electrically activatable luminescent film is disposed to illuminate areas of high transparency of a symbol carrier from behind and therefore make the conveyed meanings of the symbols recognizable. This application is particularly suitable for automobile license plates.

The known solutions have in common that they either require a power supply in order to achieve a lasting luminescent effect, or that they are based purely on reflection. Both solutions cannot eliminate the problems described above.

### BRIEF SUMMARY OF THE INVENTION

The present invention improves such marking elements in a way to permit the control areas, or the numbers and pictorial symbols disposed thereon, to be recognizable for a sufficient amount of time in the event of sudden darkness, without special provisions and operating processes, at least to such a degree that the continued operation of the device remains ensured for that duration.

The present invention provides a marking element for marking the function of a control element of an electric or electronic device with numbers or pictorial symbols, wherein said marking element comprises a first section composed of a first film having a luminescent layer to be applied to a control area of the control element, said element being provided with a number or pictorial symbol.

The underlying idea of the invention must be seen in that a film having a degree of light emission persistence is utilized as the base element. Due to electrochemical processes, the film provides a luminous display for a certain amount of time with decreasing intensity, which, if partial areas are covered, produces an at least sufficiently visible contrast in order to make the partial areas, numbers, or pictorial symbols stand out recognizably against the luminescent film section that serves as a background or base.

In a particularly preferred embodiment, a second film, which is applied over the luminescent film, is provided for applying the control symbols. This second film specifically also serves to protect the luminescent film against mechanical damage.

In a further preferred embodiment, the films used for the sections are self-adhesive films with a removable protective backing, which permits a particularly simple processing/application onto the control areas of the device.

The marking element sections may be dimensioned such that they cover the entire control area of the device, for example the front of a device. However, they may also be inserted into or applied by adhesion onto special areas to ensure the contrast effect characterized above, relative to a control symbol.

### BRIEF DESCRIPTION OF THE DRAWINGS

FIG. 1 is an exploded view of a control area of a device with the two film sections, to clarify the assembly process.

FIGS. 2A and 2B show, respectively, a top view and a sectional view of the control panel according to FIG. 1 with applied film sections.

FIG. 3 is a cross-sectional view of a second embodiment of the arrangement of the film sections on the control panel or control element of an electric device.

### DETAILED DESCRIPTION OF THE INVENTION

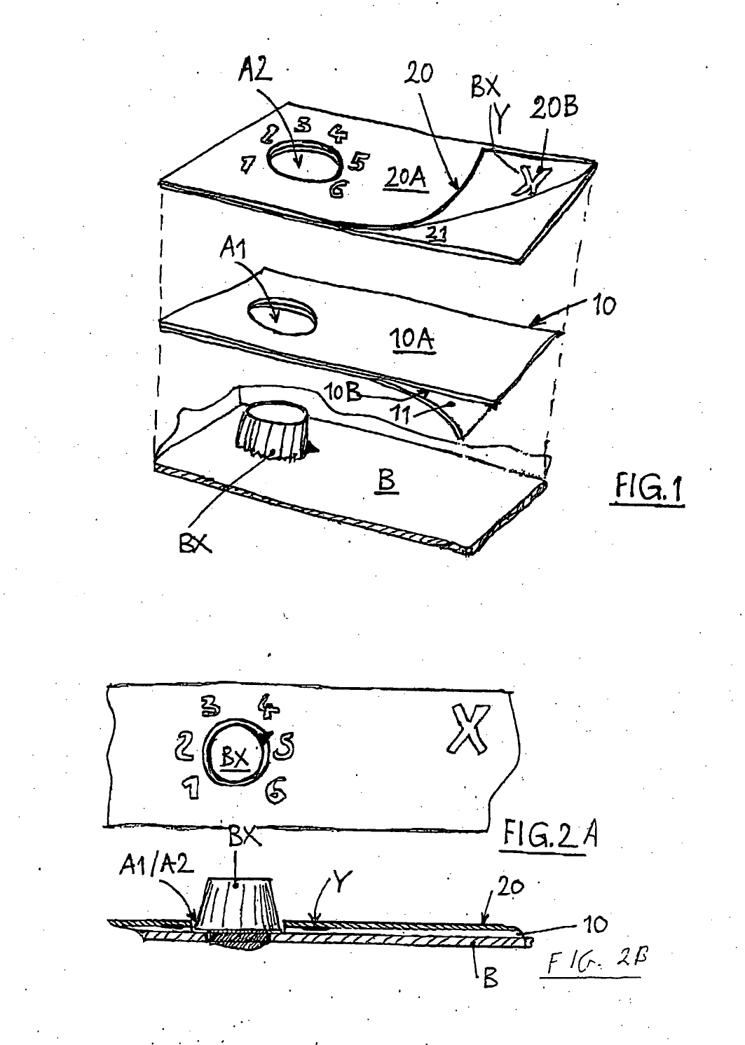

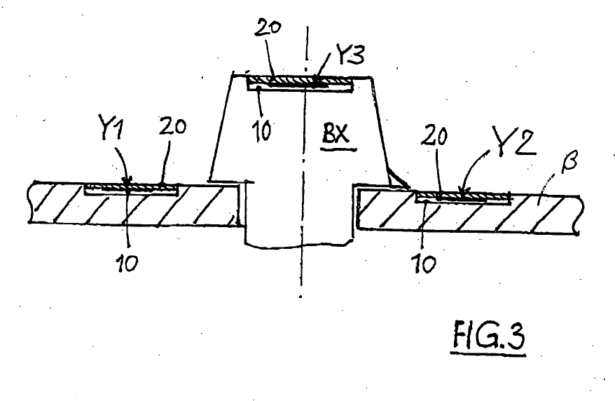

Referring to FIGS. 1, 2A and 2B, the marking element according to the invention is composed of two sections 10 and 20, which, placed over one another, are joined, e.g., glued together and held in place on the control area B of an electric device.

The first section 10 is a self-adhesive film, the upper side 10A of which faces away from the control area B. At the underside 10B of film 10, a removable protective backing 11 is initially affixed. After complete removal of backing 11, the underside 10B or the adhesive layer which is applied thereon may be joined to the control area B.

The upper side 10A is composed of, or includes, the luminescent layer, which is particularly essential here. The luminescent layer is of a substance that, after it has been exposed to normal daylight or artificial light, continues to emit light, or have an afterglow effect, when the normal light is no longer available. Such a film is commercially available, for example under the brand name “Oralux” from firm Orafol Klebetechnik GmbH in 16515 Oranienburg, Germany.

The first film section 10 features a first cutout A1 so that it may be fitted around a control knob BX on the control area B, so that the first film section 10, as indicated in FIGS. 2A and 2B, lies directly on the control area B.

The second film section 20 is also initially affixed to a removable protective backing 21. Section 20 is itself a self-adhesive film having adhesive on its reverse side 20B, which faces section 10. Control symbols such as, e.g., the symbol X or the shown numbers 1 . . . 6 are printed on the reverse side 20B of the clear or at least transparent film of the second section 20.

The protective backing 21 is removed and the second film section 20 is affixed with its adhesive side 20B onto the upper side 10A of the first film section 10 and joined by adhesion in such a way that the cutout A2 is also fitted over the control element BX, so that the final configuration shown in FIGS. 2A and 2B is attained. In this configuration, the numbers, indicated by Y in FIG. 2B, and control symbols cover the luminescent layer of the upper side 10A of the first film section.

In the event of a light outage, the numbers or pictorial symbols are back-lit from below by the luminescent layer 10A, whereby the desired contrast is achieved and the symbols are thus clearly recognizable as dark or black areas above the after-glow layer.

The dimensional conception of the arrangement of the two films on top of one another is variable: in the first embodiment according to FIGS. 1 and 2, the films extend across a large surface over the entire control area, while in a second embodiment indicated in FIG. 3 in a sectional view, flat recesses are incorporated into the control area B as well as into the upper side of the control element BX. Matching cut film sections 10 and 20 corresponding to the first embodiment are placed in the flat recesses, preferably such that the upper side 20A of the transparent cover film, which provides significant protection of the after-glowing film, is flush with the surface of the control area B or control element BX.

It is important in all applications that the sections extend beyond the outer contours of the of the pictorial symbols Y1, Y2, and Y3, such that a corresponding “illuminated framing” results that produces the desired marking effect.

The invention was described above in connection with the control area of an electric/electronic device, however, it goes without saying that it can also be utilized anywhere where the problem that was described at the beginning of a required visibility during times of light outages must remain ensured at least for a minimum amount of time.

It is also easily possible to dispense with the second film and to print the control symbols directly onto the luminescent film if only a few symbols are involved or if protection from damage is not a concern.

This application relates to subject matter disclosed in German Application Number 103 04 691.7, filed on Feb. 6, 2003, the disclosure of which is incorporated herein by reference.

The foregoing description of the specific embodiments will so fully reveal the general nature of the invention that others can, by applying current knowledge, readily modify and/or adapt for various applications such specific embodiments without undue experimentation and without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. The means, materials, and steps for carrying out various disclosed functions may take a variety of alternative forms without departing from the invention.

Thus the expressions “means to . . . ” and “means for . . . ”, or any method step language, as may be found in the specification above and/or in the claims below, followed by a functional statement, are intended to define and cover whatever structural, physical, chemical or electrical element or structure, or whatever method step, which may now or in the future exist which carries out the recited function, whether or not precisely equivalent to the embodiment or embodiments disclosed in the specification above, i.e., other means or steps for carrying out the same functions can be used; and it is intended that such expressions be given their broadest interpretation.

What is claimed is:

1. A marking element for marking the function of a control element of an electric or electronic device with numbers or pictorial symbols, wherein said marking element comprises a first section composed of a first film having a luminescent layer to be applied to a control area of the control element, and a number or pictorial symbol is provided on said first section.

2. The marking element according to claim 1, wherein, for providing the number or pictorial symbol, said element further comprises a second section composed of a clear second film carrying the number or pictorial symbol, said second section being applied on said first section.

3. The marking element according to claim 2, wherein at least one of said first and second sections is a self-adhesive film with a removable protective backing.

4. The marking element according to claim 2, wherein said second section is a self-adhesive film with a removable protective backing disposed on a reverse side of said film of said second section, and the number or pictorial symbol is disposed on the reverse side of said film of said second section.

5. The marking element according to claim 4, wherein the number or pictorial symbol is printed backwards on the reverse side.

6. The marking element according to claim 1, wherein said film is a self-adhesive film with a removable protective backing, said film has an upper side carrying said luminescent layer and an underside that is opposite to said upper side and on which said protective backing is disposed.

7. An electronic or electric device comprising: a control element; and a marking element for marking the function of the device with a number or pictorial symbol, wherein said marking element comprises a first section composed of a first film having a luminescent layer applied to a control area of said control element, and a number or pictorial symbol is provided on said first section.

8. The device according to claim 7, wherein, for providing the number or pictorial symbol, said marking element further comprises a second section composed of a clear second film carrying the number or pictorial symbol, said second section being applied on said first section.

9. The device according to claim 8, wherein at least one of said first and second sections is a self-adhesive film with a removable protective backing.

10. The device according to claim 8, wherein said second section is a self-adhesive film with a removable protective backing disposed on a reverse side of said film of said second section, and the number or pictorial symbol is disposed on the reverse side of said film of said second section.

11. The device according to claim 10, wherein the number or pictorial symbol is printed backwards on the reverse side.

12. The device according to claim 7, wherein said film is a self-adhesive film with a removable protective backing, said film has an upper side carrying said luminescent layer and an underside that is opposite to said upper side and on which said protective backing is disposed.
